(19) United States
(12) Patent Application Publication
(10) Pub. No.: US 2009/0168766 A1
(43) Pub. Date: Jul. 2, 2009

(54) Inter-Technology Bridging Over Access Points

(76) Inventors: Vedat Eyuboglu, Concord, MA (US); Douglas Norman Knisely, Wheaton, IL (US); Woojune Kim, Arlington, MA (US)

Correspondence Address: FISH & RICHARDSON PC, P.O. BOX 1022, MINNEAPOLIS, MN, 55440-1022, US

(21) Appl. No.: 11/966,516

(22) Filed: Dec. 28, 2007

(51) Int. Cl. H04L 12/66

(52) U.S. Cl. 370/353

(57) ABSTRACT

A radio node bridges a first communication session from an access terminal using a first communication protocol to a network using a second communication protocol, and requests that a second communication session between the access terminal and the network be established, the second communication session using the first communication protocol. The radio node receives instructions for the access terminal to join the second session and instructs the access terminal to transfer an active call from the first session to the second session.

### BACKGROUND

This disclosure relates to bridging calls between technologies.

Cellular wireless communications systems are designed to serve many mobile stations (MS) distributed in a large geographic area. A MS can be connected to the network of such a system through a 1xRTT (cdma2000 IS-2000) or other circuit switched voice connection or through a data connection, such as evolution-data only (Ev-DO). Voice calls can be carried over a data connection using Voice Over Internet Protocol (VoIP) technology.

The 1xRTT (cdma2000 IS-2000) protocol has been standardized by the Telecommunication Industry Association (TIA) as TIA/EIA/IS-2000, “CDMA2000 Spread Spectrum Systems Specification Release 0 Addendum 2,” 3GPP2 C.S0001-0-2 . . . 3GPP2 C.S0005-0-2, Version 14.0, May 2001, which is incorporated herein by reference. Revision A to this specification has been published as TIA/EIA/IS-2000, “CDMA2000 Spread Spectrum Systems Specification Release 0 Addendum 2,” 3?PP2 C.S0001-A . . . 3GPP2 C.S0005-A, Version 6.0, February 2002, and is also incorporated herein by reference. Revision B, Revision C and Revision D to this specification have been published as TIA/EIA/IS-856-B, 3GPP2 C.S0001-[B,C,D] . . . C.S0006-[B,C,D] and are also incorporated herein by reference. Other TIA protocols include:

(a) TIA-878-A-1 Interoperability Specification (IOS) for High Rate Packet Data (HRPD) Radio Access Network Interfaces with Session Control in the Access Network, 3GPP2A.S0008-A v2.0, May 2007 (HTTP://WWW.3 GPP2.ORG/PUBLIC_HTML/SPECS/A.S0008-A_V2.0_{—}070424.PDF);
(b) TIA-878-B, Interoperability Specification (IOS) for High Rate Packet Data (HRPD) Radio Access Network Interfaces with Session Control in the Access Network, 3GPP2 A.S0008-B v1.0, November 2006, January 2006 (HTTP://WWW.3GPP2.ORG/PUBLIC_HTML/SPECS/A.S0008-A_V2.0_{—}070424.PDF);
(c) TLA-2001.[1 . . . 6]-D-1 Interoperability Specification (IOS) for cdma2000 Access Network Interfaces—Part [1 . . . 6] (IOS v5.0.1), 3GPP2 A.S0011.16-C v2.0, January 2006;

### (d) TIA/EIA/IS-856, “CDMA2000 High Rate Packet Data Air Interface Specification,” 3GPP2 C.S00240, Version 4.0, Oct. 25, 2002; and

### (e) TIA/EIA/IS-856, “CDMA2000 High Rate Packet Data Air Interface Specification,” 3GPP2 C.S0024-A, Version 2.0, June 2005, and TIA/EIA/IS-856-B, 3GPP2 C.S0024B.

### SUMMARY

In general, in one aspect, a radio node bridges a first communication session from an access terminal using a first communication protocol to a first network using a second communication protocol, requests that a second communication session between the access terminal and a second network be established, the second communication session using the first communication protocol, receives instructions for the access terminal to join the second session, and instructs the access terminal to transfer an active call from the first session to the second session.

Implementations may include one or more of the following features. The first and second networks can be the same or different. In some examples, the first communication protocol is 1 xRTT, and the second communication protocol is VoIP.

In some examples, the request is authenticated by automatically authenticating all requests generated from the radio node. The authentication includes the radio node obtaining a security key for inclusion with the request. In some examples, the radio node is notified of a value of the security key or the radio node requests to be provided with a value of the security key. In some examples, the security key is sent directly to the radio node. In some examples, the authentication includes calculating values for authentication fields in the request.

In some examples, the radio node registers the active call using the first communication session with the network on behalf of the terminal. During registration, the radio node obtains a voice call continuity server directory number (VCC DN). The VCC DN is obtainable in numerous other ways such as during SIP INVITE exchanges or explicit SIP method exchanges. Using the VCC DN, the target Radio Access Network (RAN) (Base Station Controller/Mobile Switching Center (BSC/MSC)) initiates a call with the target VCC, allowing the target VCC to establish a bridge over which the second communication session occurs.

The second communication session is initiated by the radio node. Based on pilot reports received at the radio node, the radio node requests that the second communication session be established. The radio node's request is intercepted and routed to a Radio Network Controller/Mobile Switching Center (RNC/MSC) or BSC/MSC (i.e. the target RAN) associated with a second radio node identified in the request. The second communication session is established through the MSC and the VCC, using the VCC DN as described above. In some examples, the second communication session between the terminal and the network uses 1xRTT and passes through a cell of a macro network. After instructions to join are sent by the radio network controller or target MSC to the access terminal, the access terminal acknowledges that it has received instructions to join the second session and joins.

These and other aspects and features, and combinations of them, may be expressed as methods, apparatus, systems, means for performing functions, computer program products, and in other ways.

Advantages may include easy deployment with few core network changes. Legacy handsets can use Voice Call Continuity infrastructure to perform access point handoff without adding Voice Call Continuity features to the handset.

Other features and advantages of the invention will be apparent from the description and the claims.

### DESCRIPTION

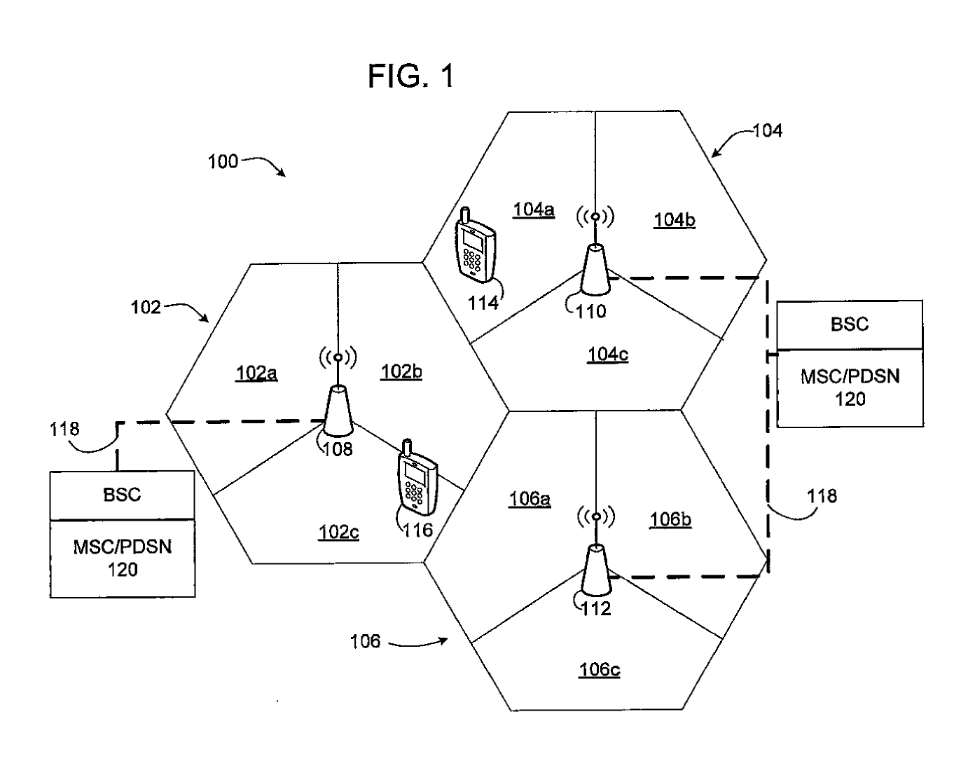

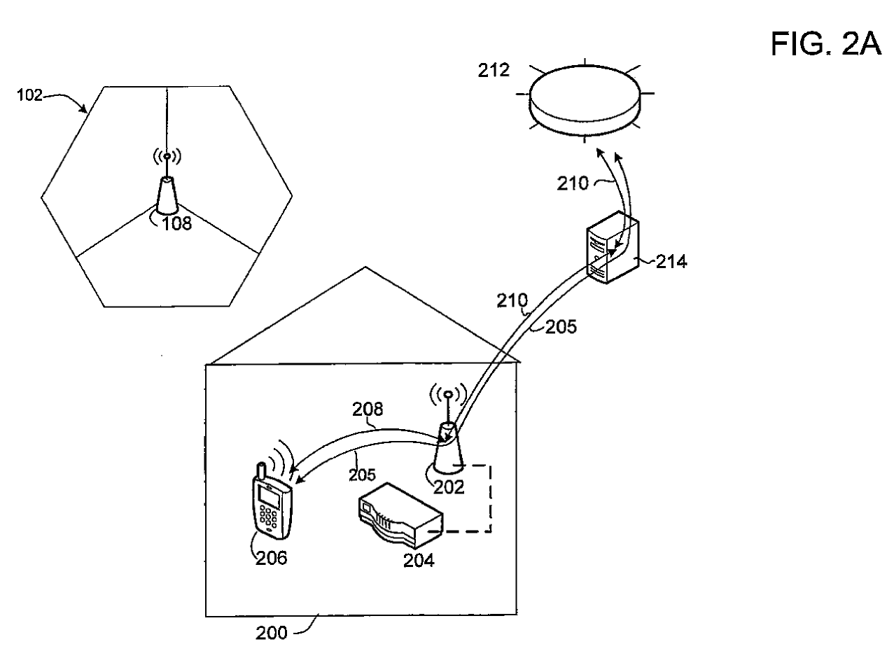

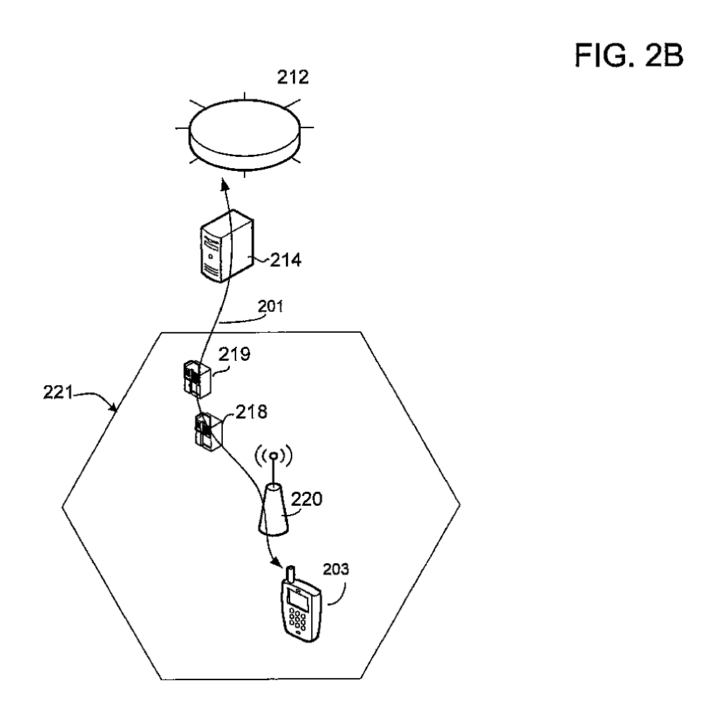

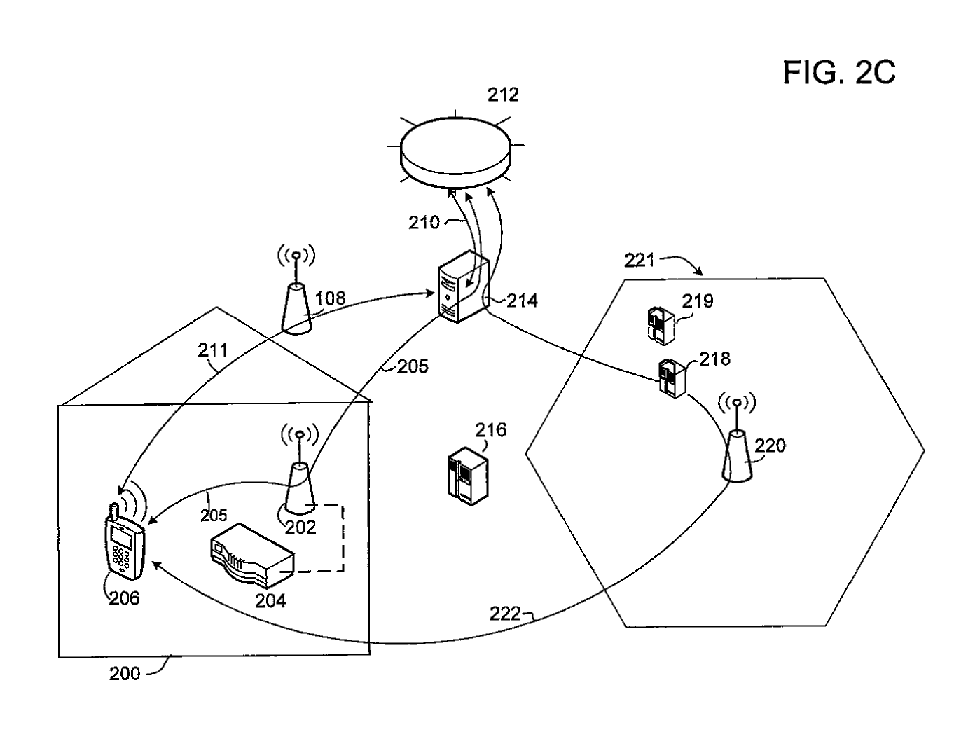

FIGS. 1, 2A, 2B and 2C show block diagrams of wireless networks.

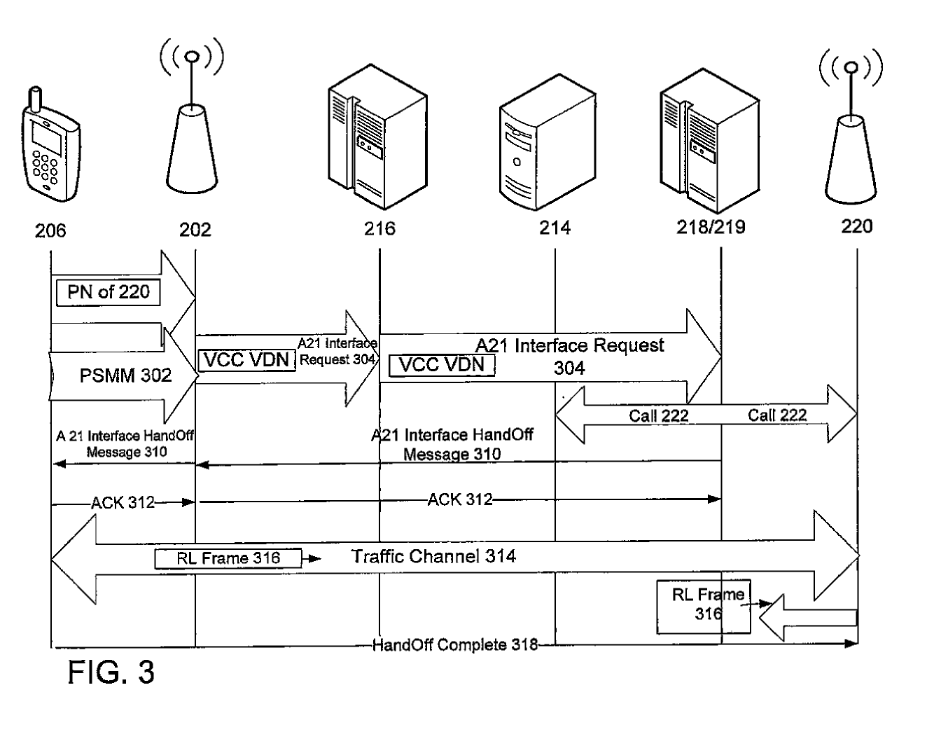

FIG. 3 shows a timing diagram.

In some examples, as shown in FIG. 1, a radio access network (RAN) 100 uses an airlink protocol such as 1xRTT or EV-DO to transmit voice or data packets between a MS, e.g., MSs 114 and 116, and a radio network access point, e.g., access points 108, 110, 112. In some examples, the radio network access point is a Base Transceiver Station (BTS), Radio Node (RN), or a Base Station (BS). In Universal Mobile Telecommunications Service (UMTS), the radio network access point is referred to as Node B. The access points are connected over a backhaul connection 118 to a Base Station Controller (BSC) and Mobile Switching Center/Packet Data Serving Nodes (MSC/PDSN) 120, which are one or more physical devices at different locations. Although this description uses terminology from the cdma2000 family of standards (IS-2000, IS-856 also known as “Ev-DO”), the same concepts are applicable to other communication methods, including but not limited to GSM, UMTS, HSDPA, WiMax, WiBro, and WiFi.

In some examples, as shown in FIG. 2A, a radio network access point 202 is deployed in a user's home 200 in a similar manner as a WiFi® access point. The radio network access point 202 is referred to as a private access point. Private access points are sometimes referred to as personal access points or base stations or as femto access points or base stations. The area served by the private access point is sometimes referred to as a femto cell. The private access point 202 uses an available high-speed internet connection, such as DSL or cable modem 204, as the backhaul with the BSC and MSC/PDSN functionality implemented at least in part in the private access point 202. Such a private access point 202 may be installed in numerous advantageous locations, such as an office, a public space, or a restaurant. The term “home” encompasses all of these locations.

In some examples, a private access point 202 is integrated into a cable modem or other network hardware, such as a router or WiFi access point. In some examples, the access point is an open access one, such as a picocell access point. A private access point 202 can differ from a picocell access point in that the private access point 202 provides access only for the user who installs it in his home 200 or those subscribers he authorizes (“closed access”), while a picocell serves a similar venue but provides access to any subscriber of the network (“open access”). A private access point may also be configured to allow “open access” in a mode similar to a picocell access point.

Referring to FIG. 2B, for a regular wireless call 201, an MS 203 communicates directly with a macro access point 220, which routes the call through one or more of a BSC 218 and MSC 219. In some examples, the MSC 219 is integrated with the BSC 218.

In the case of a private access point 202 as shown in FIG. 2A, when an authorized MS 206 is present inside the home 200 (or anywhere within range of the private access point 202), the authorized MS 206 uses the private access point 202 rather than a regular cellular radio network access point 108 to place or receive voice calls and data connections. In some examples, his occurs even if the MS 206 is within the cell 102 for that standard access point 108. The standard access point 108 is referred to as a macro access point or macro BTS to distinguish it from a private access point 202, as the standard access point 108 provides direct access to the wider RAN, referred to as the macro network.

In the example of FIG. 2A, the MS 206 uses the private access point 202 in making and receiving a voice call 205. The voice call 205 is made up of two connections, a 1xRTT connection 208 and a VoIP connection 210. The 1xRTT connection 208 runs from the MS 206 to the private access point 202. A standard MS 206 makes this 1xRTT connection 208 automatically, because the MS 206 perceives the private access point 202 as a standard radio node. In some examples, the VoIP connection 210 runs from the private access point 202 to a node 212 in the macro network 100 through a voice call continuity (VCC) application server 214, which is part of an entity known as a CSRV convergence server in certain implementations. In FIG. 2A, the call 205 is shown passing through the VCC application server 214. From the node 212, the call is connected on to its ultimate destination (i.e., another caller) through any standard or proprietary phone system. In practice, the private access point 202 connects a voice call 205 from the MS 206 to the macro network 100 (FIG. 1) by bridging the 1xRTT connection 208 to the VoIP connection 210. In some examples, the VoIP connection passes through additional network elements such as routers and private or public networks, not shown.

Referring to FIG. 2C, the CSRV and A21 Proxy 216 are gateways that compensate for the fact that certain devices are limited in the range of other devices with which they can communicate. For example, a personal access point 202 communicates with the VCC application server 214 but is not capable of communicating directly with a BSC 218, a MSC 219, or other core network entities. This occurs because the personal access point does not support the protocol needed to communicate with a BSC or a MSC. Alternatively, in some examples, the private access point 202 supports the protocols but the BSC or MSC is unable to handle a large number of communicating peer entities, which is the case when the BSC or MSC connects with private access points. The CSRV or A21 Proxy 216 bridges this communication divide, allowing a private access point 202 to effectively communicate with a BSC 218 or a MSC 219.

When the MS 206 has an active voice call 205 through the private access point 202 and moves outside of the range of the private access point 202, the call 205 is transferred to a call 222 on the macro network access point 220 serving a macro cell 221 in a process called handoff. VCC standards enable such handoffs for certain mobile stations. For example, using these standards, calls are transferred from WiFi or BV-DO-based VoIP connections to 1xRTT circuit-switched voice connections. In order to accomplish such a handoff, the VCC standards call for the MS 206 to initiate a second voice call 211 to the VCC application server 214 over the macro network 100 (e.g., using a 1 xRTT call through the macro access point 108) while the voice call 205 through the VoIP connection 210 is still active. Some existing MSs 206, such as Ev-DO MSs, are not capable of initiating this second voice call 211 while the first voice call 205 is active. Therefore, they are not able to accomplish a handoff in the manner described above.

In some of these cases, Ev-DO MSs implement 1xRTT/VoIP handoff over Ev-DO. For such cases, an Ev-DO VoIP client initiates on behalf of the MS a handoff to the 1 xRTT macro network by sending a 1xRTT origination message to a Ev-DO Radio Network Controller (RNC) using the Ev-DO protocol suite. The EV-DO RNC carries the 1xRTT origination message to the correct 1xRTT BSC/MSC using a tunnel for 1xRTT airlink messages. This tunnel is sometimes referred to as the A21 interface and the handoff that uses this interface is referred to as an A21 interface based handoff. Using a number contained within the origination message, referred to as the voice directory number (VDN) or VCC DN, the 1xRTT BSC/MSC sets up a call between the BSC/MSC and the VCC. Based on the VDN, the BSC/MSC locates the appropriate VCC. With the call setup from the BSC/MSC to the VCC, the BSC/MSC generates a 1xRTT handoff message (e.g. Universal Handoff Directive message UHDM), sending it over the A21 interface to the BV-DO RNC, which in turn sends it to the MS over the Ev-DO airlink between the EV-DO RNC and the Ev-DO VoIP client. The 1xRTT BSC/MSC prepares an airlink connection for the MS based on information sent in the 1xRTT handoff message. Upon receiving the 1xRTT handoff message from the Ev-DO RNC, the MS initiates a handoff of the call to the 1xRTT BSC/MSC by connecting to the traffic channel on the 1xRTT BSC/MSC system based on the information contained in the 1xRTTT handoff message. The VCC releases the call on the VoIP connection that came through the EvV-DO airlink of the MS.

In the example of a private access point, MSs 206 are unable to initiate the second voice call 211 while the first voice call 205 is active, because the MS 206 is connected with a private access point 202, as described in earlier sections. In this example, the MS 206 is not aware that the call 205 is completed using a VoIP connection 210, because the MS 206 is in communication with the private access point 202 using the 1 xRTT connection 208. With existing standards, these MSs handoff an active 1xRTT call from one access point to another access point through a soft or hard handoff, in which the call is not dropped, depending on the configuration of the access points. However, these existing standards do not accommodate handoff of a VoIP call to a 1xRTT call where the MS has no knowledge of or control over the VoIP call.

For such a mobile station, e.g., MS 206, the private access point 202 is used as an intertechnology handoff device, initiating the second voice call on behalf of the MS 206. Since the MS 206 is only equipped to handoff 1xRTT calls, the VoIP to 1xRTT handoff appears to be a standard 1xRTT handoff, from the perspective of the MS 206.

The private access point 202 hands off the voice call 205 that uses the 1xRTT connection 208 and VoIP connection 210 to a voice call 222 that uses only a 1xRTT connection. To facilitate this handoff, the private access point 202 emulates the MS 206 by communicating with the macro network 100 on behalf of the MS 206, as shown in FIG. 3. As the MS 206 moves, it sends 1xRTT Pilot Strength Measurement messages (PSMM) 302 containing pilot signal reports to the private access point 202. The 1xRTT PSMM 302 identifies access points accessible to the MS 202, including, for this example, the macro access point 220. Based on these reports, the private access point 202 initiates handoff by sending a call origination request 304 asking that a new call be set up and delivered to a VDN representing the call 205 over the current VoIP connection 210. The request 304 includes the VDN of the VCC application server 214.

In some examples, rather than communicating directly with the BSC 218, to which an origination request 304 would logically be sent, the private access point 202 addresses the origination request 304 to the A21 proxy 216, which by using the A21 interface forwards it to the BSC/MSC 218/219. The A21 Proxy is a specific proxy for the A21 interface and enables numerous femtocells to appear as a single RNC to the 1xRTT BSC/MSC. Without the A21 Proxy, each femoto cell looks like an individual RNC. Therefore, the A21 Proxy is optionally used in situations where a 1xRTT BSC/MSC expects to talk with only a small number of RNCs.

Because a DN (directory number or called phone number) in the 1xRTT origination request is a VDN associated with a specific VCC application server 214, when the BSC/MSC initiates a call setup to the DN, it sets up a call with the VCC. The A21 Proxy 216 intercepts the origination request 304 and redirects it to the BSC 218, which routes the request 304 to the MSC 219. The MSC 219 calls the VCC application server 214 using the VDN found in the origination request 304. When the new call 222 is set up, the VCC application server 214 joins the new call 222 to the existing call 205 using the VDN. This VDN ensures that the second voice call 222 has a connection with the object (such as another MS) on the other end of the first voice call 205. The VCC application server 214 connects the new voice call 222 to the macro network 100 (not shown), and the MSC 219 and BSC 218 connect the call to the BTS 220. The VCC application server 214 joins the new voice call 222 with the original voice call 205 as in 3-way calling, but with no third party connected.

Once the BSC/MSC 218/219 knows the VCC 214 is connected, the BSC 218 sends a UHDM handoff message 311 over the A21 interface 310 to the MS 206, by way of the private access point 202, telling the MS 206 to perform standard 1xRTT soft handoff to the target BTS 220. The MS 206 sends an acknowledgement 312 of the handoff message 311 to the private access point 202. The BTS 220 opens a traffic channel 314, an airlink connection for the MS 206 based on information sent in the handoff message 310, which it received as part of the call setup message 222. The BTS (macro access point) 220 begins receiving reverse link frames 316 from the MS 206 and passing them on to the BSC 218, connecting the MS 206 to the second voice call 222. In this way, the MS 206 transitions from the private access point 202 to the BTS 220 using hard handoff. Using the 3-way calling analogy, the MS 206 moves from the first call 205 to the second call 222, becoming the “third” party while still active as the “first” party. The MS 206 completes the handoff by sending a Handoff Complete message 318 directly through the macro BTS 220 and dropping its connection 208 to the private access point 202. The VoIP connection 210 of the first voice call 205 from the personal access point 202 to the VCC application server 214 is dropped once the MS 206 is connected to the second voice call 222 on the BTS 220 when the VCC AS 214 sends a SIP BYE/Handoff Complete message 319 to the private access point. The sending of the SIP BYE/Handoff Complete message 319 may occur anytime after the second call 222 is setup, but there should be a delay to allow the mobile to complete a handoff based on the handoff message 311. In some examples, the private access point 202 delays responding to the SIP BYE 319 until it knows that the handoff has succeeded by receiving an airlink ack message 312. By setting up the traffic channel 314 on the macro cell, through the BTS 220 and from there to the VCC server 214, before redirecting the MS 206 to it, interruptions during handoff are reduced.

The private access point to macro access point handoff is made to appear to the MS 206 as if it is an inter-MSC and/or inter-BSC hard handoff for several reasons, including that the MS 206 does not know of the A21 Proxy 216 or about VoIP-to-circuit handoff and the MS 206 views the private access point 202 as simultaneously an access point a BSC, and a MSC. However, on the network side, the handoff appears to be a VoIP-to-1xRTT Fit handoff using VCC standards, because the VCC application server 214 is able to perform a hard handoff of a VoIP call to a 1xRTT call without dropping the call.

In some examples, the private access point 202 acquires the VDN so that the private access point 202 can pass that number to the MSC 219 when requesting the new call 222. This allows the MSC 219 to connect the new call 222 from the BTS 220 to the VCC application server 214, so that the new voice call 222 can be joined to the existing voice call 205 that also goes through the VCC application server 214. A mobile station configured to use a VCC application server 214 is configured with the VDN before making the call. In some examples, the private access point 202 learns of the VDN during the MS 206 registration, such as by noting it during Session Initiation Protocol (SIP) registration of the MS 206 or during communication with an authorization and accounting (AAA) server for authentication of user information.

In some examples, the private access point 202 learns the VDN during a SIP INVITE exchange to set up the call or an explicit SIP method exchange from the private access point to the VCC, or other protocol exchange from the private access point to the VCC. Methods are also used to autonomously derive a VDN from the MS's identity and VCC identity or information tied to their identities such that no such exchange is needed between the access point and the VCC server. The location of this calculation is variable. For example, in some examples the calculation takes place at the access point. In other examples, the calculation takes place at the BSC/MSC. As the VDN number is fixed for the MS 206, it is easy to learn in the system. Even if the VCC application server 214 were to use dynamic VDN allocation, this information can be learned during the private access point's 202 SIP registration.

In some examples, the origination request 304 generated by the private access point 202 must be authenticated with shared secret data (SSD) that is shared between a home location register/authentication center (HLR/AC) and the MS 206. The origination request 304 contains authentication fields such that the origination request is authenticated by the BTS. The authentication fields are populated with values derived from the SSD. One solution to this includes modifying the A21 network interface definitions and BTS implementation such that the BTS 220 will trust any messages that come through an A21 interface and therefore not do an authentication check on the origination request 304. Another solution includes using the SSD shared feature of the VLR (visitor location register)/HLR if the HLR/AC allows the VLR to keep a shared SSD. The VLR/HLR has a SSD shared feature that allows the HLR/AC to let the VLR keep a copy of the latest SSD for a mobile. Thus, mobile authentication is carried out by the VLR, making many security transactions in 1xRTT networks faster. However, the HLR/AC determines if the VLR keeps a shared SSD. If the HLR/AC allows the VLR to keep a shared SSD, then the VLR will give the SSD to a convergence server, a CSRV, by various methods, including the case where the CSRV includes the VLR functionality. If the HLR/AC allows his, then the CSRV/VLR obtains this knowledge of the mobile's SSD. The private access point 202 can either be notified of this value or it can query the CSRV whenever it needs to generate an origination request 304. In the latter case, the access point sends the message for which the authentication fields are calculated, querying the CSRV to carry out that calculation and return the result. In the former case, the key is sent directly to the access point, which generates the authentication fields. For security reasons, the latter may be preferred.

In some examples, the CSRV becomes a VLR to enable notifying the network 100 when a user wanders out from private access point 202 coverage into macro coverage, so that the network 100 can route new calls for the mobile station correctly. This prevents the VCC application server 214 from needlessly trying to page through the private access point 202 for the user when the MS 206 has moved onto the macro network 100. Whenever the user registers trough the private access point 202, the CSRV 216 registers with the HLR as the VLR. When the user moves out into the macro network 100, the MS 206 registers with the HLR which will then notify the CSRV/VLR that the user is on a different VLR and that the CSRV/VLR's registration should be removed. This enables the VCC application server 214 to know that the MS is no longer in the private access point domain.

Although the techniques described above employ the 1xRTT air interface standard, the techniques are also applicable to other CDMA and non-CDMA air interface technologies that support femto cells and use a tunneling technology between two different technologies with a VCC or VCC-like server to enable handoff. This includes UMTS to WiFi UMTS to LIE, GSM to WiFi, GSM to LTE and other similar cases. The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other examples are within the scope of the following claims. The following are examples for illustration only and not to limit the alternatives in any way. The techniques described herein can be performed in a different order and still achieve desirable results.

What is claimed is:

1. A method comprising:
at a radio node that is bridging a first communication session from an access terminal using a first communication protocol to a first network using a second communication protocol,
requesting that a second communication session between the access terminal and a second network be established, the second communication session using the first communication protocol,
receiving instructions for the access terminal to join the second session, and
instructing the access terminal to transfer an active call from the first session to the second session.

2. The method of claim 1 in which the first communication protocol comprises 1xRTT, and the second communication protocol comprises VoIP.

3. The method of claim 1, comprising authenticating the request.

4. The method of claim 3 in which authenticating the request comprises automatically authenticating all requests generated from the radio node.

5. The method of claim 3 in which authenticating the request includes, at the radio node, obtaining a security key for inclusion with the request.

6. The method of claim 5, comprising sending the security key directly to the radio node.

7. The method of claim 3 in which authenticating the request includes calculating values for authentication fields in the request.

8. The method of claim 5, comprising notifying the radio node of a value of the security key.

9. The method of claim 5 in which the radio node requests to be provided with a value of the security key.

10. The method of claim 1 in which the second communication session between the terminal and the second network uses 1xRTT.

11. The method of claim 1 in which the radio node registers the active call with the first network on behalf of the terminal.

12. The method of claim 1, comprising establishing the second communication session through a mobile switching center and a voice call continuity server.

13. The method of claim 12, comprising establishing a bridge over which the second communication session occurs using the voice call continuity server.

14. The method of claim 12, comprising obtaining a voice call continuity server directory number using the radio node.

15. The method of claim 14 in which obtaining the voice call continuity server directory number comprises obtaining the voice call continuity server directory number during at least one of registering the terminal, SIP INVITE exchanges, and explicit SIP method exchanges.

16. The method of claim 1, comprising at the access terminal, acknowledging that it has received instructions to join the second session.

17. The method of claim 1 in which the second session passes through a cell of a macro network.

18. The method of claim 1, comprising, at the radio node, requesting that the second communication session be established based on pilot reports received at the radio node.

19. The method of claim 1, comprising intercepting the radio node's request.

20. The method of claim 19, comprising routing the request to a radio network controller associated with a second radio node identified in the request.

21. An apparatus comprising:
a radio node that is configured to
bridge a first communication session from a terminal using a first communication protocol to a first network using a second communication protocol;
request that a second communication session between the terminal and a second network be established, the second communication session using the first communication protocol;
receive instructions for the terminal to join the second session; and
instruct the terminal to transfer an active call from the first session to the second session.

22. A communication system comprising:
a radio node that is configured to
bridge a first communication session from an access terminal using a first communication protocol to a first network using a second communication protocol;
transmit a request that a second communication session between the terminal and a second network be established, the second communication session using the first communication protocol;
receive instructions for the access terminal to join the second session; and
instruct the access terminal to transfer an active call from the first session to the second session; and
a gateway configured to receive the transmitted request and redirect the request to a radio network controller associated with a second radio node identified in the request.

23. A method comprising:
intercepting a request that a second communication session between an access terminal and a network be established,
in which the request facilitates moving a call from a first communication session to the second communication session,
the first communication session using a first communication protocol and the second communication session using a second communication protocol; and
transmitting the request to a radio network controller.

24. The method of claim 23 in which the first communication protocol comprises VoIP, and the second communication protocol comprises 1xRTT.

25. The method of claim 23, comprising authenticating the request.

26. The method of claim 25 in which authenticating the request comprises automatically authenticating all requests.

27. The method of claim 23, comprising bridging the first communication session from the access terminal using a first communication protocol to the network using the second communication protocol.

28. The method of claim 23, comprising transferring the call from the first communication session to the second communication session.

29. The method of claim 23 in which the second communication session between the terminal and the network uses 1xRTT.

30. The method of claim 23, comprising establishing the second communication session through a mobile switching center and a voice call continuity server.

31. The method of claim 23, comprising instructing the access terminal to join the second session.

32. The method of claim 23, comprising at the access terminal, acknowledging that it has received instructions to join the second session.

33. The method of claim 23 in which the second session passes through a cell of a macro network.

34. An apparatus comprising:
a device that is configured to
intercept a request that a second communication session between an access terminal and a network be established,
in which the request facilitates moving a call from a first communication session to the second communication session,
the first communication session using a first communication protocol and the second communication session using a second communication protocol; and
transmit the request to a radio network controller.
